(19) United States
(12) Patent Application Publication
(10) Pub. No.: US 2026/0218844 A1
(43) Pub. Date: Jul. 30, 2026

(54) GRATING MOUNT ANCHOR

(71) Applicant: James C. White Company, Inc., Greenville, SC (US)

(72) Inventor: Thomas C. White, Greenville, SC (US)

(21) Appl. No.: 19/040,174

(22) Filed: Jan. 29, 2025

(51) Int. Cl. F16M 13/02; F16B 37/04

(52) U.S. Cl. CPC F16M 13/02; F16B 37/044

(57) ABSTRACT

A grating mount anchor that includes an elongate member, a nut retainer, a beam nut, and a set-up retainer. The nut retainer is selectively secured to the elongate member having a first side portion extending from a side of the nut retainer and a second side portion extending from an opposed side of the nut retainer. A beam nut is positioned within an internal void of the nut retainer, and a set-up retainer is selectively secured to the elongate member. The nut retainer further includes a first angled portion engaged to the first side portion of the nut retainer at an intersection angled toward the vertical axis of the nut retainer forming a first shelf, and a second angled portion engaged to the second side portion of the nut retainer at an intersection angled toward the vertical axis of the nut retainer forming a second shelf.

### FIELD OF THE INVENTION

The present invention relates generally to a grating mount anchor and more specifically relates to a grating mount anchor including a nut retainer and beam nut, wherein the beam nut is received within an internal void of the nut retainer and retained therein.

### BACKGROUND OF THE INVENTION

Many industrial properties contain a plurality of grating panels dispersed throughout and grating mount anchors are utilized for attaching items, devices, or structures onto the grating panels. The grating panels are used extensively throughout these industrial properties and can be utilized for other purposes, such as hanging devices and items therefrom. There is a need for a higher capacity and safer grating mount anchor that can attach adjacent grating panels and also be utilized for attaching devices and items therefrom. There is also a need for a grating mount anchor that is easy to install, uninstall, and reuse, but also durable enough to be utilized in an industrial property.

### BRIEF SUMMARY OF THE INVENTION

According to an embodiment of the present invention, a grating mount anchor includes an elongate member, a nut retainer, a beam nut, and a set-up retainer non-load bearing set-up retainer. The nut retainer has a vertical axis and is selectively secured to the elongate member having a first side portion extending from a side of the nut retainer and a second side portion extending from an opposed side of the nut retainer. A beam nut is positioned within an internal void of the nut retainer, and a set-up retainer is selectively secured to the elongate member. The nut retainer further includes a first angled portion engaged to the first side portion of the nut retainer at an intersection angled toward the vertical axis of the nut retainer forming a first shelf, and a second angled portion engaged to the second side portion of the nut retainer at an intersection angled toward the vertical axis of the nut retainer forming a second shelf.

According to another embodiment of the present invention, the grating mount anchor includes an elongate member having a first end and a second end with a safety end stop disposed on the second end of the elongate member. A beam nut is positioned within a nut retainer, and the nut retainer and beam nut are selectively secured to the elongate member. A set-up retainer is selectively secured to the elongate member.

According to yet another embodiment of the present invention, the first angled portion contains a first arcuate portion, and the second angled portion contains a second arcuate portion.

According to yet another embodiment of the present invention, the beam nut is generally rectangular containing a centrally located threaded bore.

According to yet another embodiment of the present invention, the nut retainer contains a bore within the top portion for receiving the externally threaded elongate member.

According to yet another embodiment of the present invention, the nut retainer contains an opening within the top portion for receiving the externally threaded elongate member.

According to yet another embodiment of the present invention, the nut retainer contains a first wing portion extending from a first end of the top portion of the nut retainer and a second wing portion extending from a second end of the top portion of the nut retainer.

According to yet another embodiment of the present invention, the internal surfaces of the first side portion and the second side portion are smooth and without obstructions.

According to yet another embodiment of the present invention, the elongate member is externally threaded and the safety end stop contains no threads.

According to yet another embodiment of the present invention, the nut retainer contains a vertical axis and is selectively secured to the elongate member having a top portion and a first side portion extending from a side of the top portion and a second side portion extending from an opposed side of the top portion.

### BRIEF DESCRIPTION OF THE DRAWINGS

The present invention is illustrated and described herein with reference to the various drawings, in which like reference numbers denote like method steps and/or system components, respectively, and in which:

FIG. 1 is a bottom perspective view of a prior art device;

FIG. 2 is a perspective view of the grating mount anchor of the present invention;

FIG. 3A is an exploded view of the grating mount anchor of the present invention;

FIG. 3B is a side view of the grating mount anchor of the present invention inserted within a grating panel;

FIG. 3C is a side view of the grating mount anchor of the present invention being rotated within a grating panel;

FIG. 3D is a side view of the grating mount anchor of the present invention rotated 90° after inserted within a grating panel;

FIG. 3E is a side view of the grating mount anchor of the present invention engaged to the grating panel;

FIG. 4A is a top perspective view of a device engaged to a grating panel by a grating mount anchor of the present invention;

FIG. 4B is a side view of device engaged to a grating panel by a grating mount anchor of the present invention; and

FIG. 5 is a to perspective view of an alternative embodiment of the nut retainer of the grating mount anchor of the present invention.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

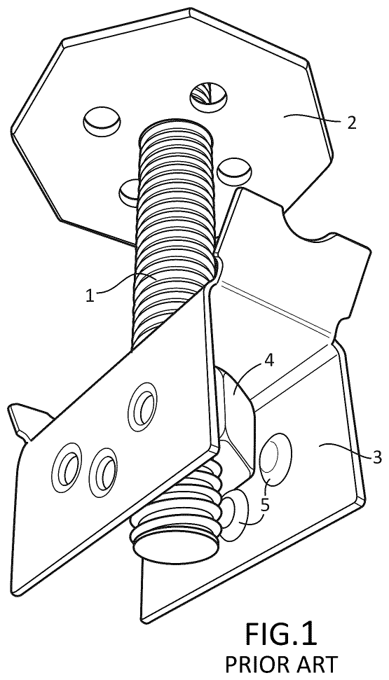

FIG. 1 discloses a prior art device sold by Grating Fasteners in Harvey, Louisiana sold under the brand name G-clip. This prior art device contains a threaded stud 1, a top 2, a lower body 3, and a nut 4. The nut 4 is retained within the internal void of the lower body 3 by a plurality of dimples 5, extending inwardly within the void.

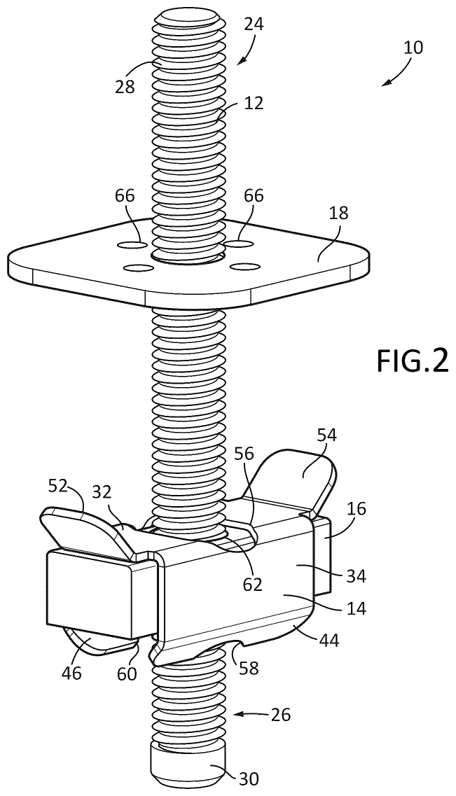

Referring now specifically to the drawings, a grating mount anchor is illustrated in FIGS. 2-5 and is shown generally at reference numeral 10. The grating mount anchor 10 includes an elongate member 12, a nut retainer 14, a beam nut 16, and a set-up retainer 18. The elongate member 12 preferably has a circular cross-section with a first end 24 and a second end 26 and externally threaded with threads 28 extending along a majority of an outer surface. A safety end stop 30 is disposed on the second end 26. The safety end stop 30 preferably has a circular cross-section, as illustrated, with an outer surface containing no threads. The safety end stop 30 is preferably integral with the elongate member 12 and formed from the same base material as the elongate member 12. The safety end stop 30, as illustrated, contains a base portion with a constant diameter that proceeds to an end portion that is tapered, wherein the diameter gradually decreases to an end portion of the elongate member 12 that forms the outermost portion of the second end 26 of the elongate member 12. While the safety end stop 30 may have a circular cross-section as illustrated, the safety end stop 30 may have other geometric shapes and cross-sections, such as square, rectangular, hexagonal, and the like. The safety end stop 30 is designed to prevent rotational movement by not containing threads, and preferably contains a smooth outer surface. The safety end stop 30, prevents the nut retainer 14 and beam nut 16 from proceeding past the safety end stop 30 on the second end 26 of the elongate member 12 during engagement to a grating panel 20. The safety end stop 30 is beneficial and prevents the nut retainer 14 and beam nut 16 from disengaging the elongate member 12 and falling below a grating panel 20 that is generally found at a high or inaccessible elevation. The safety end stop 30 is an improved safety feature, allowing for a higher capacity and a safer grating mount anchor 10.

The nut retainer 14 is selectively secured to the elongate member 12. The nut retainer 14 includes a top portion 32, a first side portion 34, and a second side portion 36. The first side portion 34 and the second side portion 36 are opposed and disposed on opposite sides of the top portion 32, each having an upper portion and a bottom portion. The first side portion 34 extends downwardly from an edge of the top portion 32, and the second side portion 36 extends downwardly from an opposite edge of the top portion 32. The top portion 32, the first side portion 34, and the second side portion 36 collectively form an internal void 38 within the nut retainer 14. The internal void 38 is enclosed by the internal surfaces of the top portion 32, the first side portion 34, and the second side portion 36. The upper portion of the first side portion 34 and the second side portion 36 are adjacent opposed edges of the top portion 32. The bottom portion of the first side portion 34 contains a first angled portion 44 that is angled inwardly towards the internal void 38 and vertical axis of the nut retainer 14. Likewise, the bottom portion of the second side portion 36 contains a second angled portion 46 that is angled inwardly towards the internal void 38 and vertical axis of the nut retainer 14. The internal surfaces of the first side portion 34 and the second side portion 36 are smooth and without any obstructions, dimples, or other type of protrusion for retaining a beam nut 16 or the like. The first and second angled portions (44,46) are shaped to contain a beam nut and as a guide to assist inserting the grating mount anchor into position between two adjacent grating bearing bars (68, 68′).

As illustrated in the figures, the first and second side portions (34, 36) extend perpendicularly outwardly from the top portion 32 in a parallel relationship, wherein the first and second side portions (34, 36) are spaced an equal distance apart and parallel to each other as the first and second side portions (34, 36) extend outwardly from the top portion 32. The bottom portion of the first and second side portions (34, 36) are located a predetermined distance from the upper portion. The angle formed at the intersection of the internal surface of the first side portion 34 and the internal surface of the first angled portion 44 is preferably greater than 90°, while the intersection serves as a first shelf 48 when the beam nut 16 is inserted into the interior void 38. Similarly, the angle formed at the intersection of the internal surface of the second side portion 36 and the internal surface of the second angled portion 46 is preferably greater than 90°, while the intersection also serves as a second shelf 50 when the beam nut 16 is inserted into the interior void 38.

The first angled portion 44 contains a first arcuate portion 58, and the second angled portion 46 contains a second arcuate portion 60. The first and second arcuate portions (58, 60) are formed within the angled portions (44, 46), extending from the outer edge of the arcuate portions (58, 60) and into the angled portions (44, 46) and having a semi-circular shape. The arcuate portions (58, 60) are preferably centrally located within the angled portions (44,46) with a diameter slightly larger than the diameter of the elongate member 12, allowing the elongate member 12 to extend through the nut retainer 14 unobstructed with the arcuate portions (58, 60) disposed adjacent the external threads 28 of the elongate member 12 when inserted into the opening of the nut retainer 14, shown as a slot 56 in FIGS. 2, 3A, 3C, 3D, 3E, and 4B.

A first wing portion 52 extends from the first end of the top portion 32, and a second wing portion 54 extends from the second end of the top portion 32. The first wing portion 52 and the second wing portion 54 are diagonally opposed and extend angularly outwardly from the exterior surface of the top portion 32. The nut retainer 14 contains a slot 56 extending from the exterior surface to the internal surface and that spans the width of the top portion 32 of the nut retainer 14, wherein a first end of the slot 56 extends into the first side portion 34 and the second end of the slot 56 extends into the second side portion 36.

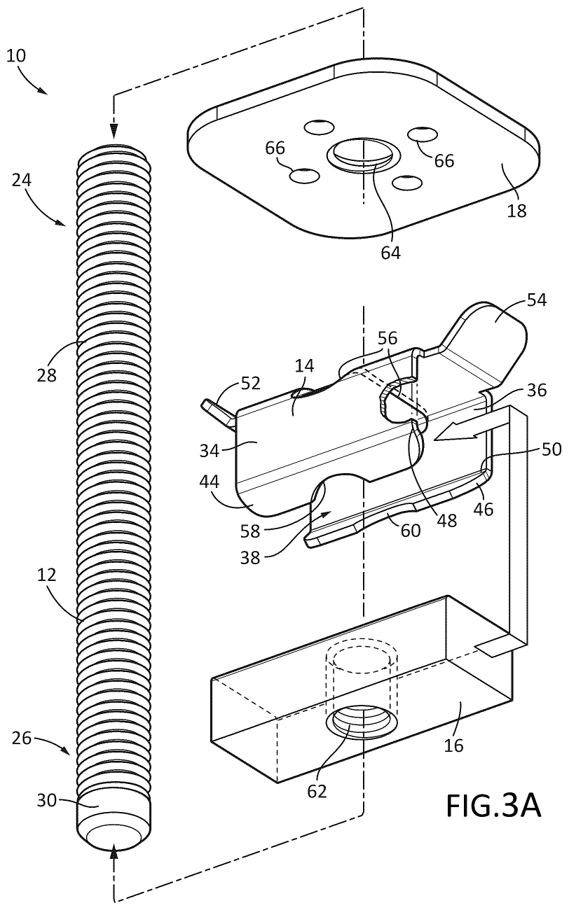

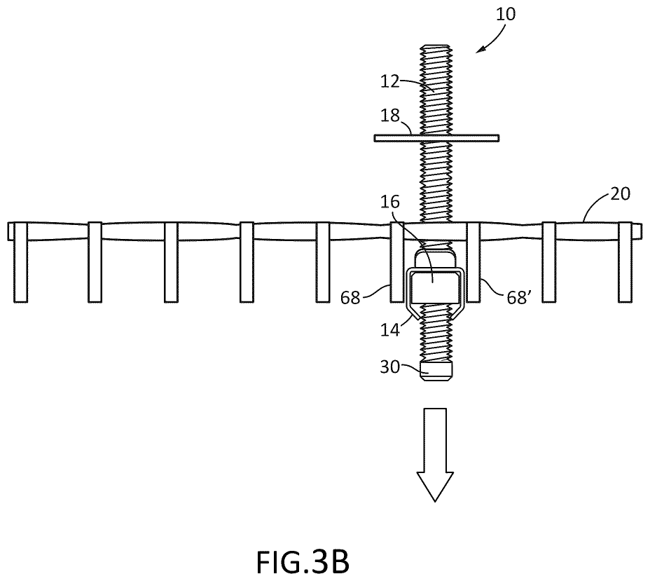

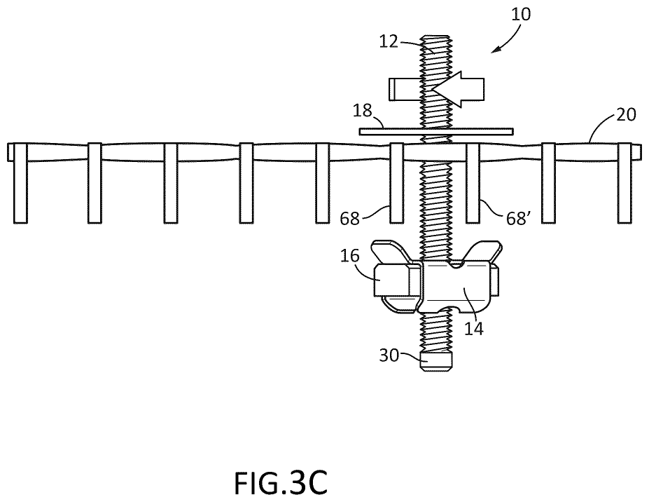

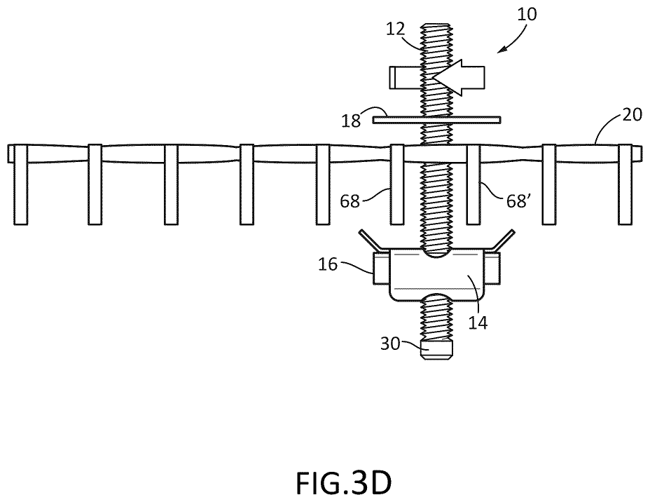

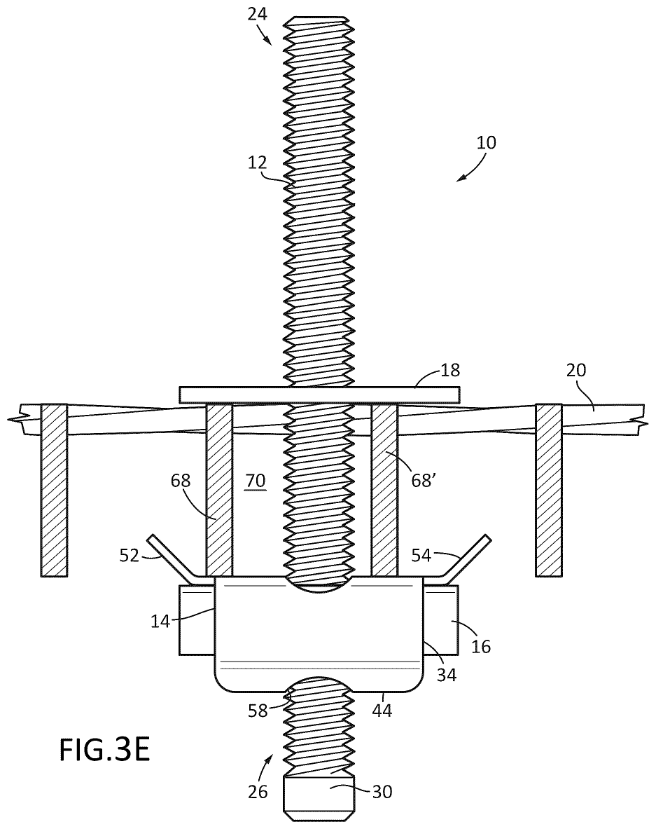

As best illustrated in FIG. 3A, the beam nut 16 is generally rectangular, having a two opposed sides, two opposed ends, a top side, and a bottom side. An edge is formed where each side meets the top side and the bottom side. A bore 62 is disposed within the beam nut 16, extending from the top side to the bottom side. The bore 62 is preferably centrally located, containing internal threads for receiving the corresponding external threads 28 of the elongate member 12. As illustrated in FIGS. 3A-3E, the beam nut 16 is inserted, received, and retained in the internal void 38 of the nut retainer 14. When inserted into the internal void 38 of the nut retainer 14, the beam nut 16 contacts the intersection of the internal surface of the first side portion 34 and the internal surface of the first angled portion 44 and internal surface of the second side portion 36 and the internal surface of the second angled portion 46. The edge of the beam nut 16, formed where the two opposed sides meet the bottom portion, contacts and rests on the intersections, acting as a shelf (48,50), to retain the beam nut 16 within the internal void 38. The beam nut 16 preferably has a length greater than the length of the internal surface of the top portion 32 of the nut retainer 14. The full length of the internal surface of the top portion 32 of the nut retainer 14 is in contact with the top surface of the beam nut 16 when a load is applied to the grating mount anchor 10 that is properly installed onto a grating panel 20. The nut retainer 14 retains and positions the beam nut 16 after the beam nut 16 has been threaded onto the elongate member 12.

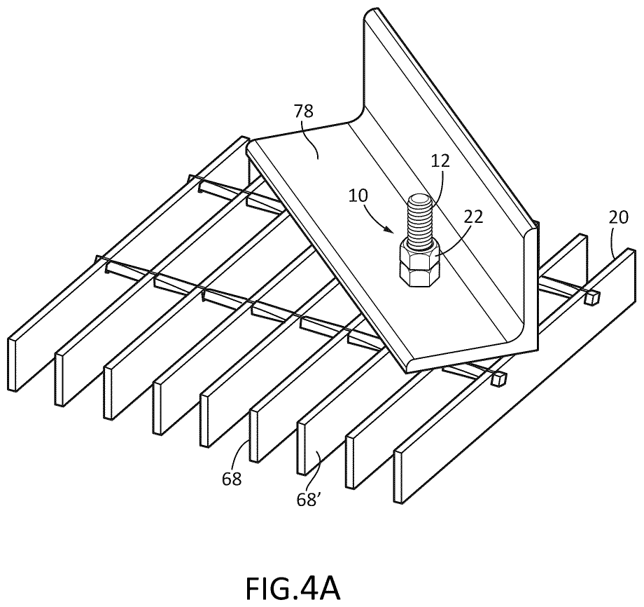

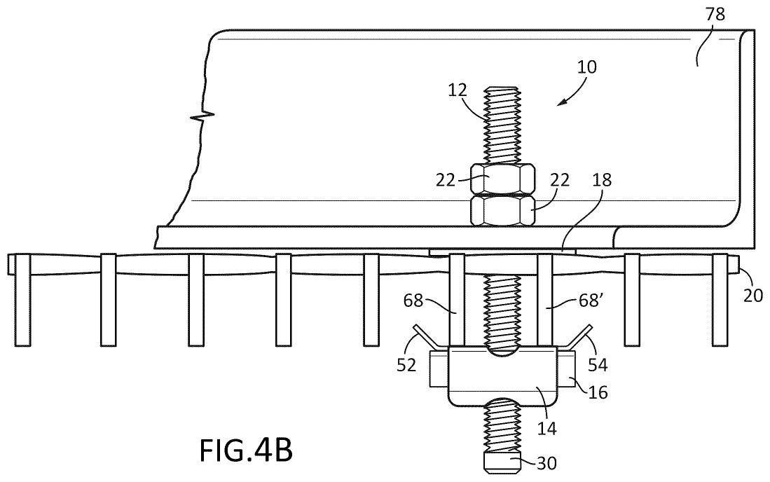

The nut retainer 14 and the beam nut 16 preferably have a width less than the width between two grating bearing bars 68 of a grating panel 20, allowing the nut retainer 14 and the beam nut 16 to be lowered between the two grating bearing bars 68, as illustrated in FIG. 3B, so that grating mount anchor 10 can be rotated 90°by the first end of the elongate member 12, as illustrated in FIGS. 3C and 3D, and aligned across the two grating bearing bars 68, as illustrated in FIGS. 3E and 4B. The nut retainer 14 and beam nut 16 have a length greater than the width between the two grating bearing bars 68 to insure they span across the two grating bars 68 when engaged, as illustrated in FIG. 3E. The beam nut 16 preferably has a length greater than the length of the first and second side portions (34, 36) of the nut retainer 14. The depth of the nut retainer 14 and beam nut 16 can be larger or increased to add load capacity to a granting mount anchor 10 until the elongate member 12 becomes the weakest component of the grating mount anchor 10.

The set-up retainer 18, as best seen in FIGS. 2, 3A, and 5, is generally square as illustrated and non-load bearing. However, the set-up retainer 18 may be any geometric shape, such as triangular, rectangular, circular, and the like. The set-up retainer 18 contains four sides, a top portion, and a bottom portion. The set-up retainer 18 may contain rounded edges where each side meets. A threaded bore 64 extends from the top portion to the bottom portion, containing internal threads for receiving corresponding external threads 28 of the elongate member 12. A plurality of spaced apart bores 66 are disposed adjacent the threaded bore 64 and preferably not internally threaded. The set-up retainer 18, as best illustrated in FIG. 3A, may contain four spaced apart bores 66, spaced an equal distance apart, and coaxially surrounding the threaded bore 64.

The set-up retainer 18 does not support any significant load as a component of a fully functional grating mount anchor 10. The set-up retainer 18 is essentially a thin gage nut with threads to match the threads of the elongate member 12 having large flat top and bottom surfaces, perpendicular to the axis of the elongate member 12. The set-up retainer 18 has three primary functions: (1) to keep the grating mount anchor 10 from falling thru the grating panel 20 while being installed; (2) to vertically position the elongate member 12 as desired to engage the grating mount anchor 10 with a item, device, structure, or the like being mounted; (3) to secure the grating mount anchor 10 snugly into place and retain it in a position to engage an item, device, structure, or the like.

The grating mount anchor 10 provides a convenient method of installation where access to the bottom of grating panels 20 is inconvenient or impossible. The designed method of installation promotes safety and saves installation time. The grating mount anchor 10 is preferably assembled prior to installation of an item, device, structure, or the like onto a grating panel 20. As illustrated in FIGS. 4A and 4B, a device 78 is engaged to a grating panel 20 using the grating mount anchor 10. The width of the nut retainer 14 and the beam nut 16 is less than the opening between two adjacent grating bearing bars (68 and 68′), as illustrated in FIGS. 3B-3E and 4A-4B, so that the nut retainer 14 and the beam nut 16 can be lowered through the grating panel 20, between the two adjacent grating bars (68, 68′), from the top of the grating panel 20, to clear the bottom of the grating bars 68, then rotated 90°, and raised to engage a grating bar 68 positioned on either side of the elongate member 12, as illustrated in FIGS. 3B-3E. The set-up retainer 18, being part of a preassembled grating mount anchor 10 will prevent the grating mount anchor 10 from dropping through the grating panel 20 during field installation and falling below the grating panel 20. The set-up retainer 18 is lowered along with the elongate member 12 to raise the nut retainer 14 and the beam nut 16 against the bottom of a pair of opposing grating bars (68, 68′), as illustrated in FIG. 3B.

The set-up retainer 18 is rotated, which in turn draws up the nut retainer 14 until the top portion 32 firmly engages the ends of the grating bearing bars (68, 68′), as illustrated in FIGS. 3C-3E. The rotation of the set-up retainer 18 occurs until its bottom portion contacts the upper surface of the grating panel 20, firmly engaging the top portion 32 of the nut retainer 14 to the grating bearing bars (68, 68′), and the set-up retainer 18 to the upper surface of the grating panel 20, preventing movement of the grating mount anchor 10, as illustrated in FIGS. 3E and 4B. The first wing portion 52 is positioned adjacent a grating bearing bar 68, and the second wing portion 54 is positioned adjacent the grating bearing bar 68′. The first wing portion and second wing portion (52, 54) has opposed outward angles that efficiently create an opening to guide the nut retainer 14 and beam nut 16 in contact with the grating bearing bars (68, 68′) and securely engage the nut retainer 14 and beam nut 16 to the grating bearing bars (68, 68′).

The set-up retainer 18 is hand tightened against the upper surface of the grating panel 20, wherein the nut retainer 14 and the beam nut 16 is properly engaged to the bottom surface of two adjacent grating bearing bars (68, 68′). A spanner wrench or the like may be utilized by the installer to lightly tighten the set-up retainer 18 into position for connecting the device 78 being anchored onto the grating panel 20. The exterior surface of the top portion of the nut retainer 14 contacts the two grating bearing bars (68, 68′) of the grating panel 20, as illustrated in FIGS. 3E and 4B, wherein the first wing portion 52 is disposed adjacent the exterior side of grating bearing bar 68 and the second wing portion 54 is disposed adjacent the exterior side of grating bearing bar 68′. The bottom surfaces of the grating bearing bars (68, 68′) contact the exterior surface of the top portion 32 of the nut retainer 14. The safety end stop 30 of the elongate member 12 ensures that the nut retainer 14 and the beam nut 16 cannot run off the bottom end of the grating mounting anchor 10 while it is being installed. The vertical position of the elongate member 12 can be adjusted to fit the assembly requirements for the item, device, structure, or the like being anchored during installation. In other words, to regulate the length of the threaded first end of the elongate member 12 above the top portion of the set-up retainer 18. Multiple grating mounting anchors 10 can used to anchor a single device to a grating panel 20 or multiple panels (not shown). Grating mounting anchors 10 generally installed from the upper surface of the grating panel 20 without accessing the bottom surface of the grating panel 20 or grating bearing bars 68. Once the grating mount anchor 10 is engaged to the grating panel 20, the grating mount anchor 10 can secure the device 78 to the grating panel 20, as illustrated in FIGS. 4A and 4B. The grating mount anchor 10 of the present invention increases the strength and stability over the prior art devices. As the set-up retainer 18 is tightened against the top surface of the grating panel 20, the wing portions (52,54), being outside of two adjacent grating bearing bars (68,68′) and the top portion 32 being against the bottom of the same two adjacent grating bearing bars (68,68′), act as a wrench to prevent rotation of the nut retainer 14 and beam nut 16 about the elongate member 12 as the grating mount anchor 10 is tightened against the grating panel 20 using a set-up retainer 18.

As illustrated in FIGS. 4A and 4B, the device 78 being secured to a grating panel 20 includes a hole, bore, opening or the like for receiving the first end of the elongate member 12. After the grating mount anchor 10 is engaged to the grating panel 20, as described herein and illustrated in FIGS. 3B-3E, the elongate member 12 is inserted and received within the hole, bore, opening, or the like of the device 78 with the device 78 progressing along the length of the elongate member 12 extending above the grating panel 20 until the device 78 contacts the set-up retainer 18 and upper surface of the grating panel 20. An attachment device 22, such as a hex nut or hex nuts, may be engaged to the first end of the elongate member for retaining and securing the device 78. While hex nuts are illustrated in FIGS. 4A and 4B, any attachment device 22 may be utilized to serve the purposes of the user or to secure and retain the device 78 to the grating mount anchor 10.

As illustrated in FIGS. 4a and 4B, the device 78 rests on the top portion of the set-up retainer 18 after the grating mount anchor 10 has been secured into place on the grating panel 20. The bores 66 are specifically spaced on the set-up retainer 18 to accept a spanner wrench. The spanner wrench is used to tighten, adjust or loosen the set-up retainer 18 during installation of the grating mount anchor 10 onto a grating panel 20. The corners on the set-up retainer 18 are rounded to prevent a point or sharp surface from a non-rounded corner from catching in the grating panel 20 or grating bearing bars 68 when set-up retainer 18 is tightened against the grating panel 20.

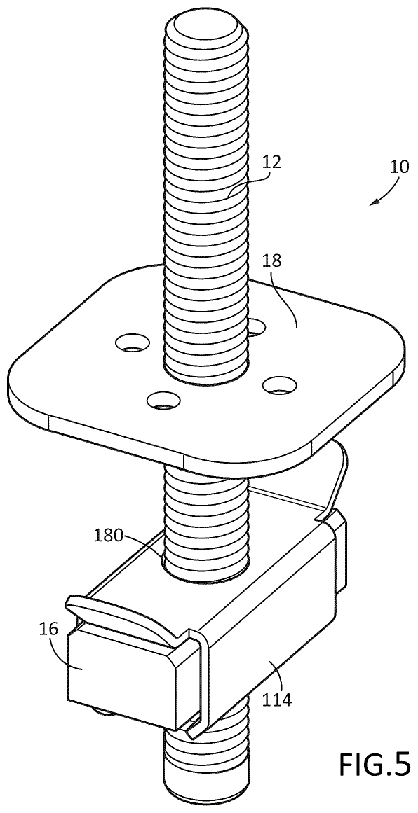

FIG. 5 shows an alternative embodiment of the nut retainer 114. The embodiment illustrated in FIG. 5 contains all of the structural elements for the embodiment shown in FIGS. 2, 3A-3E, and 4A-B and described above, including the functionality and method of installation to a grating panel 20, except this embodiment of the nut retainer 114 contains an opening that is a circular bore 180. The bore 180, preferably centrally located, extends from the exterior surface to the internal surface of the top portion, providing access to the internal void. The bore 180 is preferably not internally threaded.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A grating mount anchor, comprising:
an externally threaded elongate member;
a nut retainer with a vertical axis selectively secured to the elongate member having a top portion and a first side portion extending from a side of the top portion and a second side portion extending from an opposed side of the top portion;
a first angled portion engaged to the first side portion at an intersection angled toward the vertical axis of the nut retainer forming a first shelf;
a second angled portion engaged to the second side portion at an intersection angled toward the vertical axis of the nut retainer forming a second shelf;
a beam nut positioned within the nut retainer; and
a set-up retainer selectively secured to the elongate member.

2. The grating mount anchor according to claim 1, wherein the first angled portion contains a first arcuate portion and the second angled portion contains a second arcuate portion.

3. The grating mount anchor according to claim 1, wherein the beam nut is generally rectangular containing a centrally located threaded bore.

4. The grating mount anchor according to claim 1, wherein the nut retainer contains an opening within the top portion for receiving the externally threaded elongate member.

5. The grating mount anchor according to claim 1, wherein the nut retainer contains a first wing portion extending from a first end of the top portion of the nut retainer and a second wing portion extending from a second end of the top portion of the nut retainer.

6. The grating mount anchor according to claim 1, wherein the set-up retainer contains a threaded bore for receiving the externally threaded elongate member.

7. The grating mount anchor according to claim 1, wherein the beam nut contacts the first shelf and the second shelf, preventing rotational movement independent of the nut retainer.

8. The grating mount anchor according to claim 1, wherein the internal surfaces of the first side portion and the second side portion are smooth and without obstructions.

9. A grating mount anchor, comprising:
an elongate member having a first end and a second end;
a nut retainer selectively secured to the elongate member;
a beam nut positioned within the nut retainer;
a set-up retainer selectively secured to the elongate member; and
a safety end stop disposed on the second end of the elongate member.

10. The grating mount anchor according to claim 9, wherein the elongate member is externally threaded and the safety end stop contains no threads.

11. The grating mount anchor according to claim 9, wherein the nut retainer contains a vertical axis and is selectively secured to the elongate member having a top portion and a first side portion extending from a side of the top portion and a second side portion extending from an opposed side of the top portion.

12. The grating mount anchor according to claim 9, further comprising:
a first angled portion engaged to the first side portion at an intersection angled toward the vertical axis of the nut retainer forming a first shelf; and
a second angled portion engaged to the second side portion at an intersection angled toward the vertical axis of the nut retainer forming a second shelf.

13. The grating mount anchor according to claim 9, wherein the beam nut is generally rectangular containing a centrally located threaded bore.

14. The grating mount anchor according to claim 9, wherein the set-up retainer contains a threaded bore for receiving the externally threaded elongate member.

15. A grating mount anchor, comprising:
an externally threaded elongate member;
a nut retainer with a vertical axis selectively secured to the elongate member having a top portion and a first side portion extending from a side of the top portion and a second side portion extending from an opposed side of the top portion;
a first angled portion engaged to the first side portion at an intersection angled toward the vertical axis of the nut retainer forming a first shelf;
a second angled portion engaged to the second side portion at an intersection angled toward the vertical axis of the nut retainer forming a second shelf;
a beam nut positioned within the nut retainer;
a set-up retainer selectively secured to the elongate member; and
a safety end stop disposed on the elongate member.

16. The grating mount anchor according to claim 15, wherein the first angled portion contains a first arcuate portion and the second angled portion contains a second arcuate portion.

17. The grating mount anchor according to claim 15, wherein the beam nut is generally rectangular containing a centrally located threaded bore.

18. The grating mount anchor according to claim 15, wherein the nut retainer contains an opening within the top portion for receiving the externally threaded elongate member.

19. The grating mount anchor according to claim 15, wherein the nut retainer contains a first wing portion extending from a first end of the top portion of the nut retainer and a second wing portion extending from a second end of the top portion of the nut retainer.

20. The grating mount anchor according to claim 15, wherein the set-up retainer contains a threaded bore for receiving the externally threaded elongate member.
